(19) United States
(12) Patent Application Publication
(10) Pub. No.: US 2026/0277265 A1
(43) Pub. Date: Sep. 17, 2026

(54) JOYSTICK ASSEMBLY

(71) Applicant: Sensata Technologies, Inc., Attleboro, MA (US)

(72) Inventors: Ed C. O'Neill, Victoria, MN (US); Paul R. Erickson, Prior Lake, MN (US); Benjamin D. Johnson, Blaine, MN (US); Peter N. Ladas, Eden Prairie, MN (US); James A. Reuss, Burnsville, MN (US)

(73) Assignee: Sensata Technologies, Inc., Attleboro, MA (US)

(21) Appl. No.: 18/990,568

(22) PCT Filed: Oct. 20, 2023
(86) PCT No.: PCT/US2023/077445

§ 371 Date: Dec. 20, 2024

Related U.S. Application Data
(60) Provisional application No. 63/418,277, filed on Oct. 21, 2022.

(51) Int. Cl. G05G 9/047; G06F 3/0338

(52) U.S. Cl. CPC G05G 9/047; G05G 2009/04733; G05G 2009/04755; G06F 3/0338

(57) ABSTRACT

A joystick assembly includes an improved plunger assembly with two magnets positioned for sensing by a hall sensor. The joystick assembly also includes a cartridge that can be selectively removed, for instance, for repairing or replacing aspects of the cartridge. The joystick assembly can also include a stop feature that improves over existing joystick designs. The joystick assembly may be used in connection with an electronic architecture that can be used with joystick assemblies in different applications.

### CROSS-REFERENCE TO RELATED APPLICATIONS

This application claims the benefit of priority of PCT International Application No. PCT/US2023/077445, filed Oct. 20, 2023, titled “JOYSTICK ASSEMBLY,” which claims priority to U.S. Provisional Patent Application No. 63/418,277, filed Oct. 21, 2022, and titled “Joystick Assembly,” the entirety of which are hereby incorporated by reference.

### FIELD OF THE TECHNOLOGY

The subject disclosure relates to joysticks, and more particularly to joystick assemblies for controlling work vehicles and other equipment.

### BACKGROUND OF TECHNOLOGY

Some machines, especially industrial machines, are capable of being operated remotely. For example, a remote user can interact with a user interface that is connected, e.g., wirelessly or via a wired connection, to the machine. In these arrangements, the user input at the user interface causes a corresponding movement of the machine. In some examples, the user interface is embodied as a joystick. For example, a conventional joystick may include a handle or other feature as an interface that a user manipulates. For example, the handle may be movable in a single axis, multiple axes, and/or otherwise, with the movement being sensed and converted to a control signal for the machine being controlled.

However, conventional joysticks have relatively large margins of error. For example, some joystick assemblies use a magnet and hall effect sensor to determine movement of the joystick, but such constructions suffer from a flux density gradient that limits the resolution of the sensed movement. Moreover, conventional joystick systems, including spring-biased portions of the joystick assembly, are often difficult to manufacture and/or service. In addition, conventional joystick assemblies cannot reliably establish travel limits for the handle controlled by the user, resulting in unwanted or inconsistent over-or under-travel. Also in examples, conventional joystick assemblies often require specialized electronic architectures, e.g., depending on the type, sophistication, and/or capability of the joystick.

Accordingly, there is a need in the art for improved joystick assemblies and systems that precisely and reliably control machines, that are easier to manufacture, assemble, and/or service, that have improved travel limitation features, and/or that have improved adaptability for different machines and/or control schemes.

### SUMMARY OF THE TECHNOLOGY

The subject technology relates to improved joystick systems and methods of using such systems. For example, aspects of this disclosure relate to improved joystick designs with improved measurement resolution. Additional aspects of this disclosure relate to improved joystick designs that are readily assembled, disassembled, serviced, and/or the like. Still further aspects of this disclosure relate to improved joystick designs with improved travel limits. Additional aspects of this disclosure relate to improved control designs for integrating joysticks into control systems.

### BRIEF DESCRIPTION OF THE DRAWINGS

So that those having ordinary skill in the art to which the disclosed systems and techniques pertain will more readily understand how to make and use the same, reference may be had to the following drawings.

FIG. 1 is a perspective view of a joystick system, in accordance with aspects of this disclosure.

FIG. 2 is a partial cross-sectional view of a portion of the joystick system of FIG. 1 taken along taken along section line 2-2 in FIG. 1, in accordance with aspects of this disclosure.

FIG. 3A is a cross-sectional view of a plunger assembly for use with a joystick system, such as the joystick system of FIGS. 1 and 2, in accordance with aspects of this disclosure.

FIG. 3B is an exploded perspective view of the plunger assembly of FIG. 3A, in accordance with aspects of this disclosure.

FIG. 4 is a perspective view of a containment device for containing one or more magnets in a plunger assembly, such as the plunger assembly shown in FIGS. 3A and 3B, in accordance with aspects of this disclosure.

FIG. 5 is a cross-sectional view of a portion of an alternative joystick assembly, in accordance with aspects of this disclosure.

FIG. 6 is a cross-sectional view of a portion of the alternative joystick assembly shown in FIG. 5, in accordance with aspects of this disclosure.

FIGS. 7A and 7B are partial perspective views showing additional aspects of the alternative joystick assembly shown in FIGS. 5 and 6, in accordance with aspects of this disclosure.

FIG. 8 is a partial side view of an alternative joystick assembly showing aspects of a travel limit feature, in accordance with aspects of this disclosure.

FIG. 9 is a partial cross-sectional view of the alternative joystick assembly of FIG. 8, in accordance with aspects of this disclosure.

FIG. 10 is an electrical architecture for use with joystick assemblies, in accordance with aspects of this disclosure.

### DETAILED DESCRIPTION

The subject technology overcomes many of the prior art problems associated with joystick assemblies. In brief summary, the subject technology provides an improved joystick sensing system that results in improved operator control. Without limitation, the improvements can provide increased precision of movement of the joystick and/or the tool or implement to be controlled by the joystick, safer operation of such tools and/or implements, and/or improved user satisfaction. However, this disclosure is not limited to these improvements, and not all implementations of the systems and techniques described herein may result in these improvements. Moreover, while aspects of this disclosure may be particularly useful in joystick systems used with industrial machines, the systems and techniques described herein may be useful with many joystick applications.

As noted above, joysticks are increasingly used to remotely control machines, implements, and/or the like. Conventional joystick designs are often imprecise, leading to improper and in some instances, dangerous, control of machines. For example, improper control of a machine can result in damage to the machine, harm to objects and/or people in proximity to the machine, and/or the like. In contrast, aspects of this disclosure provide improved joystick systems with improved control accuracy, improved assembly and serviceability, and/or improved control features. Aspects of the disclosure will now be explained in more detail with reference to the Figures, in which the same reference numerals are used in multiple figures to identify the same feature.

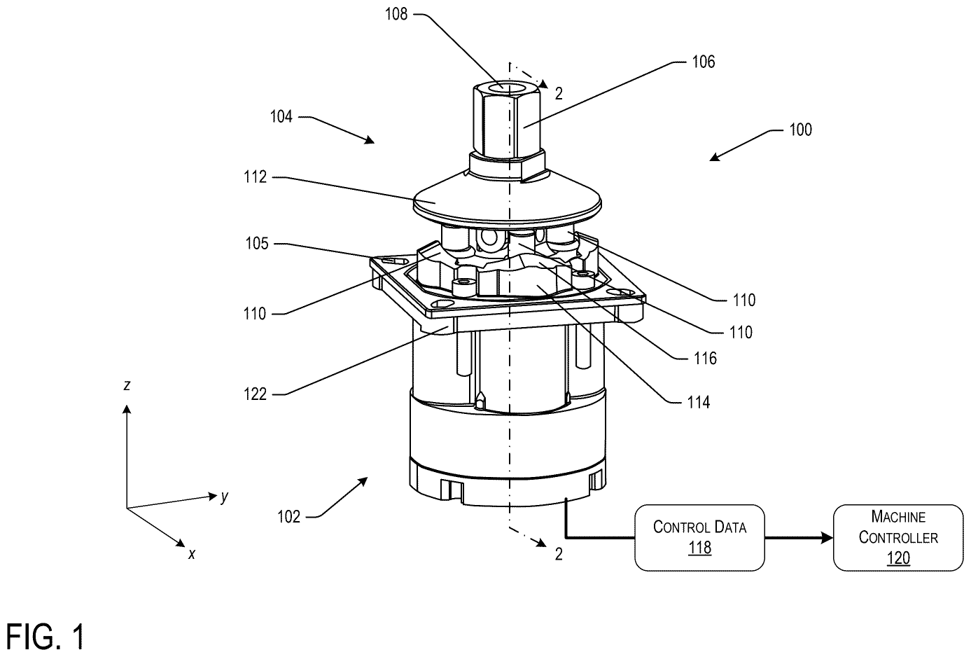

FIG. 1 is perspective view of a joystick system 100 according to aspects of this disclosure. As illustrated, the joystick system 100 includes a body 102 and an interface portion 104. Generally, the interface portion 104 is configured to move relative to the body 102. More specifically, the movement of the interface portion 104 may be sensed (and quantified), with a machine or equipment (not shown) being operated in accordance with the movement of the interface portion 104. In examples, the body 102 can include one or more mounting holes 105, e.g., for mounting the body 102 to a fixed surface or the like.

The interface portion 104 may be configured to couple to a user interface device, such as a handle, joystick, or the like. For example, a top of the interface portion 104 is illustrated as including a plurality of flats 106 and a bore 108. In examples, a compatible handle (not shown) can have one or more interior surfaces that cooperate with the flats 106 and/or a protrusion complementary to the bore 108. These complementary surfaces can facilitate movement of the interface portion 104 corresponding to user-initiated movement of the handle, e.g., by coupling the handle to the interface portion 104. In some examples, the bore 108 can be threaded for cooperation with a corresponding thread on the handle. Other surfaces, features, and/or structures may also or alternatively be included on the interface portion 104 to facilitate coupling of one or more elements.

As also illustrated, and as will be discussed in more detail below, the joystick system 100 includes a plurality of plungers 10 (of which portions of three are visible in FIG. 1). The plungers 110 are partially disposed in the body 102 of the joystick system 100 and extend a distance above the body 102. In examples, the plungers 110 are configured to move in a vertical direction (when the joystick system 100 is in the orientation of FIG. 1). More specifically, and as detailed further herein, the interface portion 104 of the joystick system includes an actuating surface 112 extending from a central portion of the interface portion 104 that contacts the plungers 110 to selectively move the plungers 110, e.g., vertically within the body 102 of the joystick system 100.

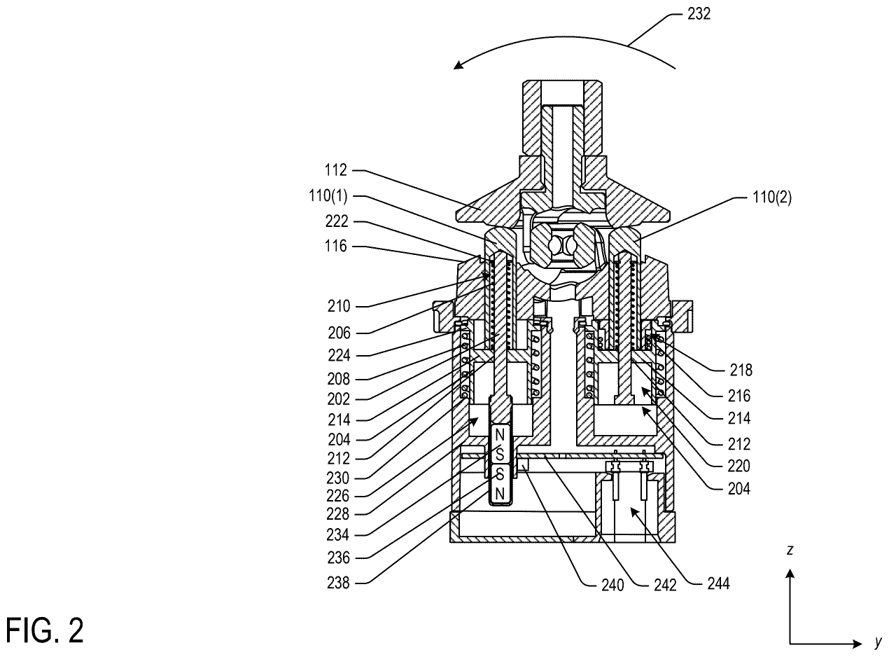

FIG. 1 also shows a stop feature 114. The stop feature 114 comprises a continuous wall disposed radially outwardly from the plungers 110. In examples, the stop feature 114 is a rigid structure that is positioned to be contacted by an outer periphery of the actuating surface 112 to limit travel of the actuating surface 112 (and thus the interface portion 104). In some conventional systems, the travel limits are set at each of the plungers 110, e.g., to limit plunger travel. Instead, the illustrated design limits movement of the interface portion 104, which can be easier to implement, cheaper to implement, and/or otherwise beneficial. As illustrated, the stop feature 114 has a contoured upper or stop surface 116. In this arrangement, the stop surface 116 has a varied height, e.g., to limit travel differently in different directions. As will be appreciated, the stop surface 116 can be varied from that illustrated. Moreover, although the stop feature 114 is illustrated as being substantially contiguous about the circumference, in other examples, the stop feature 114 may be embodied as two or more separate and/or discontinuous elements. Function of the stop feature 114 and the stop surface 116 are detailed further below, including with reference to FIGS. 2, 8, and 9.

As schematically illustrated in FIG. 1, the joystick system 100 can be configured to generate and output control data 118 for use at a machine controller 120 associated with a machine or other system (not shown) to be controlled by the joystick system 100. The control data 118 may be control signals generated in response to movement of the interface portion 104, e.g., as measured via movement of the plungers 110. In other implementations, the control data 118 may be sensor data generated at the joystick system 100 corresponding to movement of the interface portion 104. In the former example, the joystick controller is configured to sense movement of the interface portion 104 and generate control signals based thereon, whereas in the latter example, the machine controller 120 (and/or some other system remote from the body 102 of the joystick system 100) may be configured to process the sensor data to generate control signals for input to the machine controller 120. In either of these examples, the movement of the interface portion 104 is sensed and used to generate control signals for controlling a machine, implement, or the like (not shown).

The example of FIG. 1 is for illustration only. Modifications and changes are contemplated. For example, although the body 102 is illustrated as being a substantially cylindrical housing, other shapes can be used. Moreover, although the mounting holes 105 are illustrated as being formed in a mounting surface 122 generally circumscribing the body 102, other mounting features may be provided, as will be appreciated by those having ordinary skill in the art with the benefit of this disclosure. In still further examples, the joystick assembly 100 may be configured as a free unit, e.g., not intended for mounting to a surface or structure. In these examples, the mounting holes 105 and/or other mounting features may be omitted entirely.

FIG. 2 is a cross-sectional view of the joystick system 100, taken along the section line 2-2 in FIG. 1. FIG. 2 shows additional components that are obscured in FIG. 1. For example, FIG. 2 shows additional details of the plungers 110. The plungers 110 generally cooperate with a plunger follower 202, an intermediate body 204, a first spring 206, and a second spring 208. In examples, and as detailed further herein, one of the plungers 110 and its corresponding instance of the plunger follower 202, the intermediate body 204, the first spring 206, and/or the second spring 208 may be provided as a cartridge selectively disposed in a bore formed in the body 102.

In the illustrated example, each of the plungers 110 is a generally cylindrical body defining an internal, elongated cavity 210. The plunger follower 202 is axially aligned with the plunger 110 and is partially disposed within the elongated cavity 210. The plunger follower 202 also passes through an axial opening 212 of the intermediate body 204. A first end of the plunger 110 (an upper end in FIG. 2) is positioned to be selectively contacted by a portion of the actuating surface 112 of the interface portion 104. A second, opposite end of the plunger 110 (a lower end in FIG. 2) contacts an upper surface of a wall 214 of the intermediate body 204.

As illustrated in FIG. 2, the intermediate body 204 has a substantially cylindrical sidewall 216 extending between an open top and an open bottom. The wall 214 is formed as a horizontal wall disposed between the top and bottom open ends of the intermediate body 204. Accordingly, the intermediate body 204 includes a first, upper volume 218 bounded by the wall 214 (on the bottom) and the sidewall 216 and a second, lower volume 220 bounded by the wall 214 (on the top) and the sidewall 216. The axial opening 212 extends through the wall 214, to provide a passageway between the first, upper volume 218 and the second, lower volume 220.

The first spring 206 is a helical spring disposed in the elongated cavity 210 of the plunger 110 and around the plunger follower 202. The first spring 206 is retained at a lower end by the upper surface of the wall 214 of the intermediate body 204 and at an upper end by a retaining clip 222 coupled to an upper end of the plunger follower 202. In the illustrated example, the first spring 206 biases the upper end of the plunger follower 202 (and thus the upper end of the plunger 110) away from the upper surface of the wall 214 of the intermediate body 204. In examples, the weight of the plunger follower 202 is sufficient to overcome the spring force of the first spring 206, e.g., such that the lower end of the plunger follower 202 contacts the upper surface of the wall 214 of the intermediate body 204. Alternatively, the interface portion 104 may be positioned to contact the top of the plunger 110, to overcome the spring force of the first spring 206 and inhibit (upward) motion of the plunger 110.

As also illustrated in FIG. 2, the intermediate body 204 includes a circumferential protrusion 224 extending radially outwardly from an outer surface of the sidewall 216. The intermediate body 204 is contained in a bore 226 in a housing 228 comprising the body 102. The bore 226 includes a step 230 and, in the illustrated example, the second spring 208 is a helical spring configured to surround the intermediate body 204. The second spring 208 is retained, in the axial direction, between the circumferential protrusion 224 and the step 230 of the bore 226 in the housing 228. Accordingly, the second spring 208 is configured to bias the intermediate body 204 (and thus the plunger 110 and, in some instances, the plunger follower 202) out of the bore 226. As detailed herein, the intermediate body 204, the plunger follower 202 and/or the plunger 110 may be formed as a cartridge that is configured as a single unit, e.g., for selective insertion and/or removal from the bore 226.

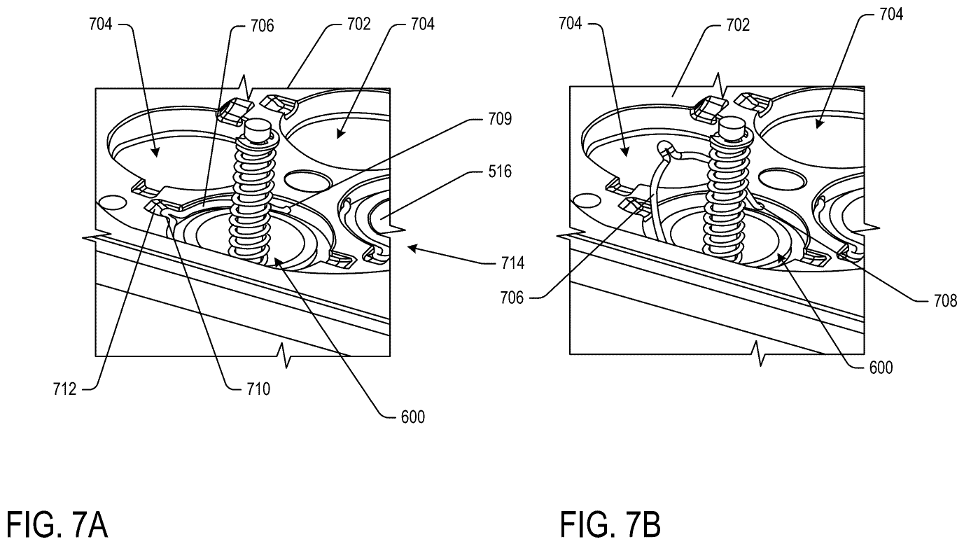

The intermediate body 204 is retained in the bore 226 against the biasing force of the second spring 208. For example, the joystick assembly 100 may include a mechanical stop proximate a top of the intermediate body 204 and/or proximate an upper surface of the circumferential protrusion 224. An example of a mechanical stop is illustrated in detail in FIGS. 7A and 7B, and described in detailed below.

In the example of FIG. 2, two instances of the plungers 110 (e.g., a first plunger 110(1) and a second plunger 110(2)) are shown. The illustrated plungers 110 are aligned along an axis, e.g., the y-axis, passing through a central (vertical) axis, e.g., the z-axis. Stated differently, the two plungers 110 are directly opposite each other about the z-axis of the joystick system 100 and extending generally along axes parallel to the z-axis. In this example, when the interface portion 104 is moved generally in the direction shown by arrow 232 (e.g., rotationally about the x-axis), the first plunger 110(1) is pressed downward against the bias of the second spring 208. Specifically, the plunger 110(1) presses on the wall 214 of the intermediate body 204 to move the intermediate body 204 (downward) against the biasing force of the second spring 208. In this example, the second plunger 110(2) may move upward as a result of the spring force of the first spring 206, or when the weight of the second plunger 110(2) is sufficient to overcome the spring force of the first spring 206, the second plunger 110(2) will remain in the illustrated position, e.g., unchanged.

As also illustrated in FIG. 2, the plunger follower 202 associated with the first plunger 110(1) has an associated first magnet 234 and an associated second magnet 236. The magnets 234, 236 are retained in a magnet retainer 238 that is coupled to a distal or lower end of the plunger follower 202. In operation, the position of one or more of the magnets 234, 236 (and thus the position of the plunger follower 202 and/or the associated plunger 110(1)) is sensed by a sensor 240 (shown schematically in FIG. 2). For instance, the sensor 240 may be a hall sensor that detects a magnitude of a magnetic field created by the magnets 234, 236 using the hall effect. In the example of FIG. 2, the sensor 240 is associated with or in communication with a board 242, which may be a printed circuit board, a printed circuit board assembly, or the like. In at least one example, the sensor 240 may be a hall sensor coupled to the board 242. An output from the sensor 240 may be processed at the board 242, e.g., to generate the control data 118. As also shown in FIG. 2, an electrical connector 244 may be connected to the board 242, e.g., to facilitate a wired connection with a machine to be controlled by the joystick system 100 or some other external system. In other examples, the board 242 may have an associated wireless transmitter, e.g., to wirelessly transmit the control data 118 to the machine (or a machine controller).

In the example of FIG. 2, the first magnet 234 and the second magnet 236 are arranged such that like poles are adjacent or, in some instances, touching. That is, in the example of FIG. 2, the south pole of the first magnet 234 is proximate the south pole of the second magnet 236. More specifically, in the illustrated example the south pole of the first magnet 234 is arranged below the north pole, whereas the second magnet 236 is disposed such that the south pole is above the north pole. Accordingly, as the plunger 110(1) is moved from an uppermost position to a lowermost position, e.g., moved down, the sensor 240 will first sense the north pole of the second magnet 236, then the south pole of the second magnet 236, the south pole of the first magnet 234, and the north pole of the first magnet 234. With this arrangement, the use of two magnets and/or the orientation of the magnets allows for adequate flux density gradient at the hall sensor 240, which may result in high resolution measurements through the full range of travel of the joystick system 100, e.g., as opposed to single magnet designs. Although the illustrated examples show the south poles being adjacent to each other, in other examples, the first and second magnets 234, 236 may be inverted, such that the north poles are adjacent, and the south poles are spaced from each other.

In the example of FIG. 2, only the first plunger 110(1) assembly includes the magnets 234, 236 and has an associated sensor 240. For example, because the plungers 110(1), 110(2) are opposed along an axis through a central, vertical axis, movement of the first plunger 110(1) will be opposite that of the second plunger 110(2), such that only the movement of one of the plungers (the first plunger 110(1) in the illustrated example) need be measured. In other examples, however, both of the plungers 110(1), 110(2) (as well as any or all additional plungers) may include associated magnets and sensors. For instance, by providing both plungers 110(1), 110(2) with magnets and associating each with a sensor, redundant measurement can be taken, e.g., to confirm proper functioning of the joystick system 100.

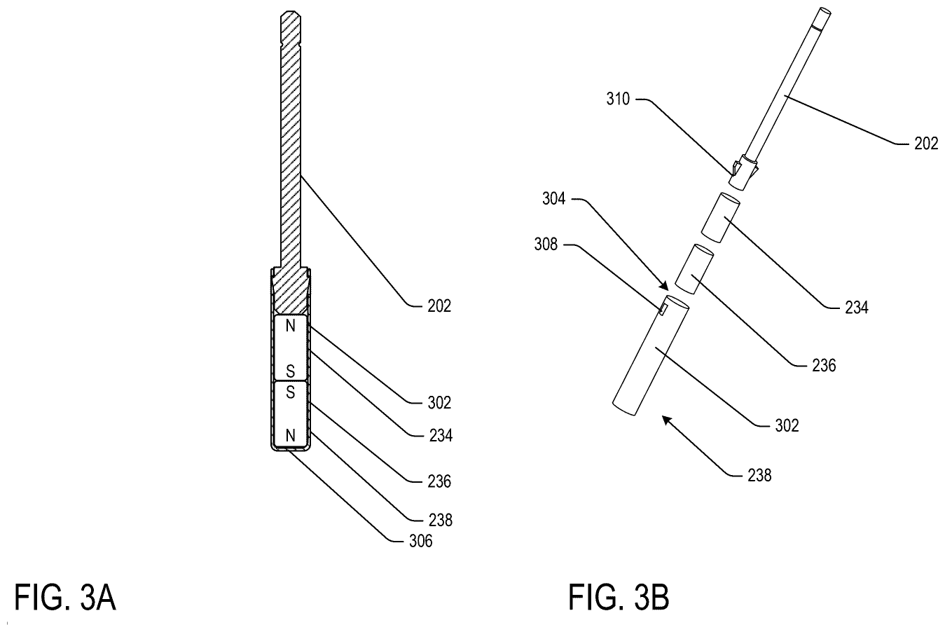

FIGS. 3A and 3B show additional features of the plunger follower 202, the first magnet 234, the second magnet 236, and the magnet retainer 238. As shown in those Figures, the magnet retainer 238 has a generally cylindrical sidewall 302 extending between an open end 304 and an opposing, bottom end 306. The magnets 234, 236 are placed into the magnet retainer 238 via the open top 304. The magnet retainer 238 also includes one or more openings 308 arranged proximate the open end 304. The plunger follower 202 has one or more protrusions 310 proximate an end thereof. When the plunger follower 202 is inserted into the open top 304 of the magnet retainer 238, the protrusions 310 on the plunger follower 202 engage with the one or more openings 308 of the magnet retainer 238, e.g., to retain the magnets 234, 236 in the magnet retainer 238. For instance, the protrusions 310 may snap into the openings 308.

Although not illustrated in FIGS. 3A and 3B, the magnets 234, 236 may be axially spaced from each other, e.g., there may be a gap between the magnets 234, 236. For instance, the gap may allow for an amount of over-travel to allow for the protrusions 310 to be appropriately seated or “snapped” into place relative to the openings 308. In examples, the magnets 234, 236 may also be secured to each other via a magnet adhesive, an epoxy, or the like.

In the example illustrated, the plunger follower 202 may made of a first material and the magnet retainer 238 is made of a second material. In examples, using two materials of appropriate length in this manner can compensate for the net effect of a differential coefficient of thermal expansion for the materials. That is, the materials may be selected to diminish the sensing target (magnet) movement due to thermal expansion. Moreover, by retaining the magnets 234, 236 in the magnet retainer 238, assembly of the joystick system 100 may be simplified.

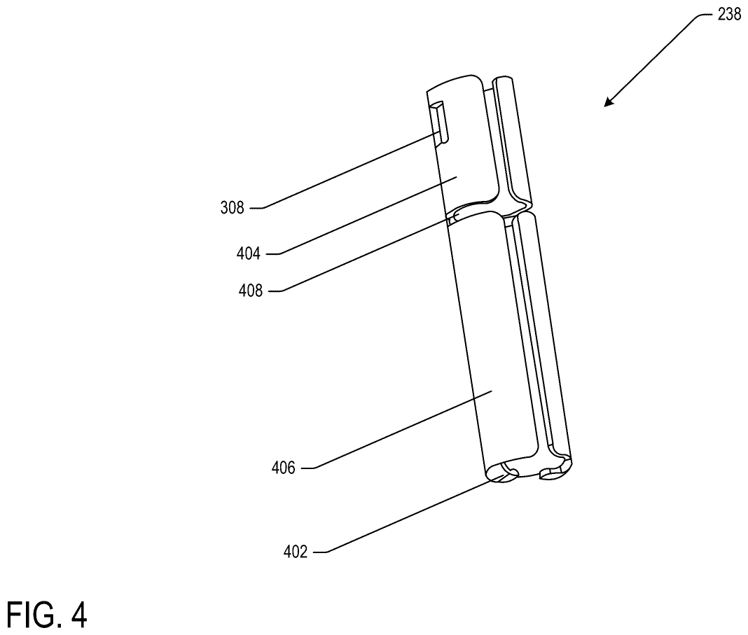

FIG. 4 is a perspective view of another implementation of the magnet retainer 238. More specifically, and as illustrated, the magnet retainer 238 includes the openings 308 proximate a top end thereof. The magnet retainer 238 also includes one or more tabs 402 formed as the bottom surface. In examples, the tabs 402 may be configured to deflect, e.g., away from a volume defined by the magnet retainer 238 for containing the magnets 234, 236 to facilitate overtravel of the plunger follower 202 when being inserted into the magnet retainer 238. As noted above, the magnets 234, 236 are arranged such that the same poles are configured next to each other (e.g., S-S or N-N at the interface of the first and second magnets). Accordingly, the magnets 234, 236 generate opposing forces that tend to repel the magnets. The tabs 402 and the plunger follower 202 are configured to counteract these forces, e.g., to retain the magnets in the magnet retainer 238.

In examples, the magnet retainer 238 of FIG. 4 may be formed of a single piece of sheet metal. For instance, and without limitation, the magnet retainer 238 can be bent to define the cylindrical outer surface, and the tabs 402 can be bent relative to the cylindrical shape. Other configurations and/or methods for manufacturing the magnet retainer also are contemplated. Also in the example of FIG. 4, the cylindrical body includes a top section 404 and a bottom section 406 separated by a gap 408. In this example, the gap 408 may allow for the top section 404 to deflect more easily, e.g., to facilitate insertion of the protrusions 310 of the plunger follower 202 into the openings 308.

As will be appreciated from the foregoing, the example joystick system 100 of FIGS. 1-4 includes a dual opposed magnet design that resolves the flux density gradient problem present with a single magnet. Moreover, the mechanical component size and material selections, e.g., of the plunger follower 202 and/or the magnet retainer 238, may be selected to counter the thermal expansion and negate or greatly reduce its influence to provide a linear sensing system that can utilize the increased accuracy and resolution with the proposed design. Moreover, the snap fit mechanism described can hold the magnets 234, 236 in the magnet retainer 238. The magnet retainer 238 may include a bent tab to provide a spring force to resist the repelling magnets. Accordingly, aspects of this disclosure can provide a low cost, easy to manufacture design that holds the opposing magnets in the needed position for the life of the joystick system 100.

For example, aspects of the joystick system 100 may incorporate a hall effect linear sensing system that includes a dual magnet design wherein two magnets are affixed with like poles touching or adjacent each other. When the north poles of the magnets 234, 236 are adjacent, as the joystick 100 is moved from one end of travel to the other, the hall sensor is directly adjacent to the S, then the N pole of the first magnet, then the N pole of the second magnet and finally the S pole of the second magnet. As noted above, in another example the poles may be switched so the S poles of the two magnets are adjacent. The orientation of the magnets allows for adequate flux density gradient at the hall sensor for high resolution measurements throughout the full joystick range of travel.

For adequate accuracy of the linear sensing system, the components are designed such that the material stack between the PCBA containing the hall cell (e.g., as the sensor 240) through the retention mechanism of the magnets has materials and corresponding component lengths that are selected so thermal expansion is greatly reduced or eliminated. This may allow for little or no influence on the accuracy of the sensing system based on the temperature the joystick is used within.

Also in examples of this disclosure, the snap fit between the plunger follower and the magnet retainer, e.g., at the openings 308 and the protrusions 310, provides adequate force and retention strength to keep the two opposing magnets restrained together or with an adequately small gap based on sensor magnetic field requirements. The overtravel of the snap fit may be paired with a bent tab (e.g., the tabs 402 of FIG. 4) that acts as a spring or similar biasing member to force the magnets together. In some examples, glue, epoxy, and/or other retention mechanisms may be provided to hold the magnets 234, 236 more securely in the correct location, e.g., relative to each other and/or relative to the magnet retainer 238.

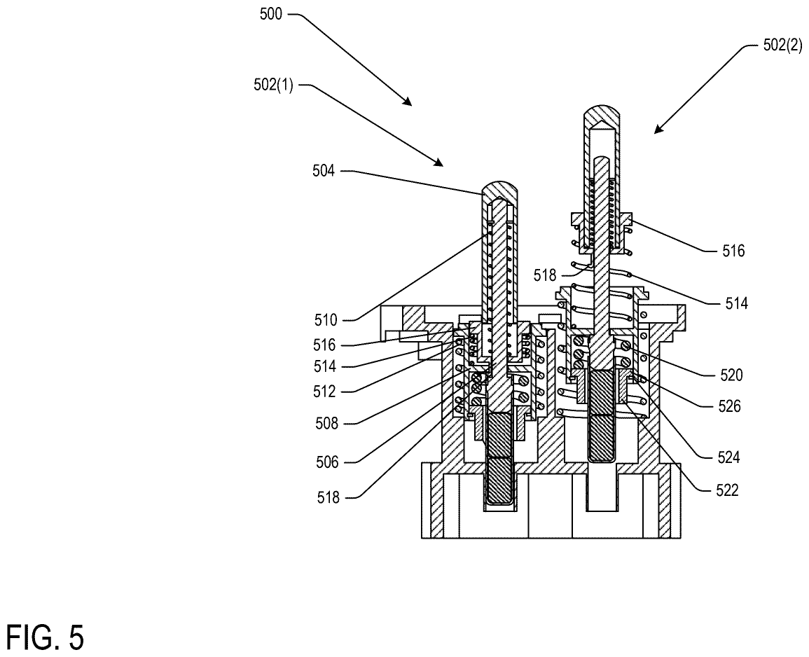

FIG. 5 shows an additional implementation of aspects of an alternative joystick assembly 500 according to aspects of this disclosure. More specifically, FIG. 5 illustrates two plunger assemblies 502(1), 502(2) (collectively, the plunger assemblies 502) similar to those described above. In this example, each of the plunger assemblies 502 includes a plunger 504, a plunger follower 506, an intermediate body 508, a first spring 510, and a second spring 512. The plunger 504, the plunger follower 506, the intermediate body 508, the first spring 510, and the second spring 512 may be, or generally correspond to, the plunger 110, the plunger follower 202, the intermediate body 204, the first spring 206, and the second spring 208, respectively. These features are not described further here.

The plunger assemblies 502 also include a third spring 514. The third spring 514 is disposed above the horizontal wall of the intermediate body 508 and contacts a flange of a cartridge retainer 516. The cartridge retainer 516 includes a lower tab 518 that is configured to selectively couple to the intermediate body 508. As in the example of FIG. 2, the intermediate body 508 includes a cylindrical sidewall, a wall that partitions the length of the cylindrical sidewall, and an axial opening through the wall. As shown in the first plunger assembly 502(1), the lower tab 518 extends through the opening in the wall of the intermediate body 508 and catches a lower surface of the wall, to secure the cartridge retainer 516 to the intermediate body, e.g., against a spring force of the third spring 514. Also in the first plunger assembly 502(1), the intermediate body 508 is positioned (and secured) in a bore in the housing of the body, generally as in the arrangement described above in connection with FIG. 2. In the second plunger assembly, the cartridge retainer 516 is selectively decoupled from the intermediate body 508, and the intermediate body is decoupled from the housing. That is, the first plunger assembly 502(1) is illustrated in an assembled state, whereas the second plunger assembly 502(2) is illustrated in an exploded, or disassembled state. As also illustrated, in the example of FIG. 5, the plunger 504 contacts the cartridge retainer 516, instead of the intermediate body 508, as in the example of FIG. 2.

Also in the example of FIG. 5, a fourth spring 520 is retained in a lower section of the intermediate body 508, e.g., between a lower surface of the wall partitioning the inner volume of the intermediate body 508 and a lower retaining portion 522. In this example, the lower retaining portion 522 is retained against the force of the fourth spring 520 by a retainer 524, which may be a clip or the like. In more detail, the retaining portion 522 is formed as a sleeve that surrounds a portion of the magnet retainer and includes a flange 526 that extends outward from a cylindrical body. The retainer 524 may be snapped or otherwise placed in a groove formed in an inner surface of the sidewall of the intermediate body 508 and contact the flange 526 of the retainer from a

[symbol]

The arrangement of FIG. 5 may ease assembly and/or service of a joystick assembly. For instance, the plunger assemblies 502 may be embodied as cartridges that are readily removed and replaced, e.g., to accommodate different user preferences (e.g., different spring stiffnesses, plunger lengths, or the like), to repair broken components, or the like. For instance, by releasing the intermediate body 508, the second spring 512 will bias the intermediate body 508, along with the additional components of the plunger assembly 502 out of the bore of the housing. For example, several of the components of the plunger assembly 502 may be embodied as a cartridge. Once removed, the retainer 524 may be removed to facilitate removal of the retaining portion 522 and the fourth spring. Removal of the retaining portion 522 may further facilitate access to the lower tab 518 of the cartridge retainer 516, e.g., to facilitate detachment of the cartridge retainer 516, the second spring 514, the plunger 504, and/or the like.

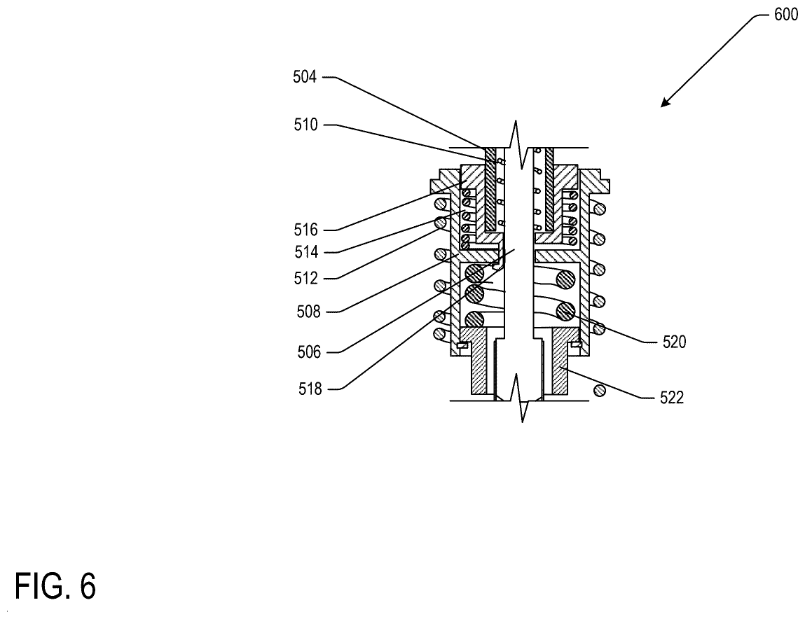

FIG. 6 shows an example of a portion of a cartridge 600 as just described. Specifically, the cartridge 600 may include the intermediate body 508, the plunger 504, the plunger follower 506, the first spring 510, the cartridge retainer 516, the second spring 514, the fourth spring 520, and/or the lower retaining portion 522. As will be appreciated, the second spring 512 will bias the intermediate body 508 (and thus the cartridge 600) out of the bore of the housing. In some examples, the entire cartridge 600 can be removed and replaced with a new instance of the cartridge 600.

The arrangement of FIGS. 5 and 6 can also facilitate repair and/or replacement of other aspects of the cartridge 600. For example, by releasing the tab 518, the third spring 514 will bias the cartridge retainer 516 away from the intermediate body 508. Once separated from the intermediate body 508 in this manner, the third spring 514 can be serviced and/or replaced. Moreover, the plunger 504 can be readily removed to access the first spring 510.

FIGS. 7A and 7B are perspective views of the cartridge 600 retained in a housing 702. As illustrated, the housing has a number of bores 704 (four in the example). Each of the bores 704 is configured to receive one of the cartridges 600. As also illustrated in FIGS. 7A and 7B, a retention feature 706 is provided to retain the cartridge 600 in the bore 704. In this example, the retention feature 706 is an arcuate bar with ends 708 configured to be received in apertures 709 formed in sidewalls in the bores 704. The retention feature 706 may be a cartridge retaining spring, e.g., made of spring wire. In operation, with the cartridge in place in the bore 704, a technician or other assembler may hold the cartridge in the bore against the force of the second spring and insert the ends 708 of the retention feature 706 into the receiving apertures 709. As also illustrated, the retention feature 706 can be pivoted in the apertures, e.g., to pivot relative to the housing 702. In FIG. 7A, the retention feature 706 is laid flat, e.g., disposed generally horizontally to retain the cartridge 600 in the bore. In examples, the retention feature 706 can include a tab 710 that can be pressed into a corresponding receptacle 712 in the housing 702. In the illustrated arrangement, the tab 710 can be deformed for reception into the receptacle 712, with the deformed tab 710 applying a force on the receptacle 712 that retains the tab 710 in the receptacle 712. In contrast, in FIG. 7B, the retention feature 706 is pivoted relative to the position of FIG. 7A. For example, the retention feature 706 in FIG. 7B may have just been inserted (e.g., prior to being pressed into place as in FIG. 7A) or may be ready for removal (e.g., by removing the ends 708 from the apertures 709 of the housing), for instance, to replace or service the cartridge 600.

FIG. 7A also shows a portion of a second cartridge 714 that includes an instance of the cartridge retainer 516 discussed above. The cartridge retainer associated with the cartridge 600 (as well as additional features including the plunger) has been removed to show how the first spring 510 may be accessed with the cartridge 600 in the housing 702, e.g., by removing the cartridge retainer only (with the cartridge still secured in the housing).

In example implementations, a cartridge can contain one or more springs and can be assembled off the production line. Once the relevant spring(s) is/are installed in the cartridge, e.g., based on a desired application, the cartridge can be installed in a bore in a housing of the joystick assembly. The cartridge is secured in place using the retention feature 706. Once secure, all haptic springs are locked in position within the bore. Spring combinations for each bore can thus be assembled individually, rather than need to constrain all four bores simultaneously, as in conventional designs.

Moreover, aspects of this disclosure allow for individualizing cartridges. For instance, the cartridge 600 may have a relatively more rigid second spring than the second cartridge 714. Accordingly, the joystick assembly may facilitate easier movement in one direction than in a second, different direction. For example, by changing properties of the cartridges, it may be more relatively easier to move a controlled machine in a first direction and relatively more difficult to move the machine in a different, second direction.

Similarly, when spring replacement is required or desired, an operator can partially disassemble the cartridge, e.g., by first removing the cartridge and/or by removing the cartridge retainer 516 with the cartridge still secured to the housing 702. For instance, the design allows for individual metering springs to be replaced, pre-compresses springs to ease assembly and servicing, and/or addresses major assembly issues of conventional designs. In accordance with examples of this disclosure, the cartridges are removed, serviced, and/or replaced as needed, and without the need to completely disassemble all springs in all bores, as in previous designs.

As will be appreciated from the foregoing, aspects of this disclosure can provide a spring retention system that constrains haptic springs in a joystick assembly, e.g., for improved initial assembly and ease of servicing in the field. Aspects of this disclosure include a cartridge containing a number of springs and moveable features, and retention features that allow for installation and/or servicing of the cartridges individually.

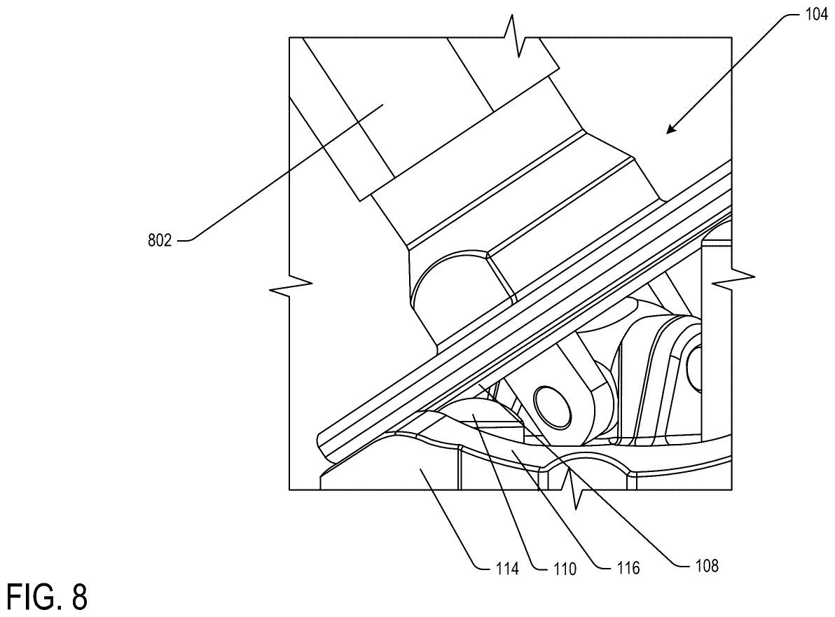

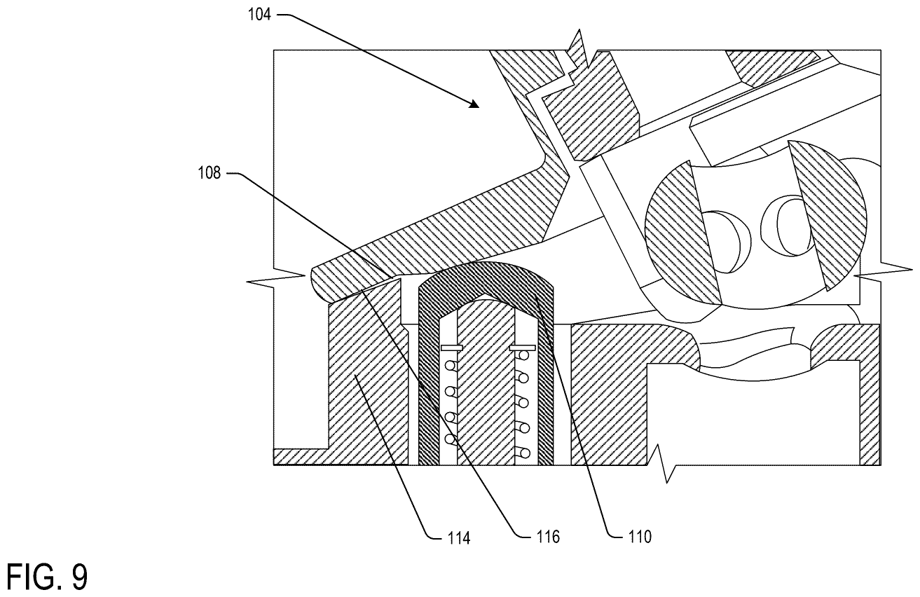

FIGS. 8 and 9 show additional aspects of a joystick assembly. Specifically, FIGS. 8 and 9 more clearly show the interface of the actuating surface 112 with the stop feature 114 and the stop surface 116. As illustrated, especially in FIG. 9, the actuating surface 112 contacts the stop surface 116 to prevent further downward actuation of the plunger 110. That is, the plunger-style electronic joystick described herein has travel limits set by the stop surface 116 disposed radially outward from the plungers, not by limiting the travel of the plungers as in some conventional examples.

Having the stop surface 116 limit travel of the actuating surface 112 (and thus the interface portion 104) can provide improvements over conventional arrangements. For instance, some conventional arrangements are based on electrohydraulic joysticks that use hardened steel plungers and plunger actuators and the overload forces are transmitted through the plunger. That is, these conventional joysticks require the use of specialty materials, e.g., costly hardened metal, for the plunger and/or plunger actuator to withstand industry required overload forces. Lower quality materials will significantly reduce the product overload capability in these examples. However, according to the present disclosure, because the travel limit is set by a separate piece radially outside the plunger, the plunger and the plunger actuator can be made of lower cost materials while still providing the same or better overload strength, resulting in a lower cost to produce. Moreover, the stop surface 116 can be configured in many ways, e.g., to provide different distances of travel from the plungers 110. In at least some examples, the stop feature 114 can be removed and replaced, e.g., with another stop feature having different contours, features, and/or functionality.

FIG. 8 also shows an example of a handle 802 coupled to the interface portion 104.

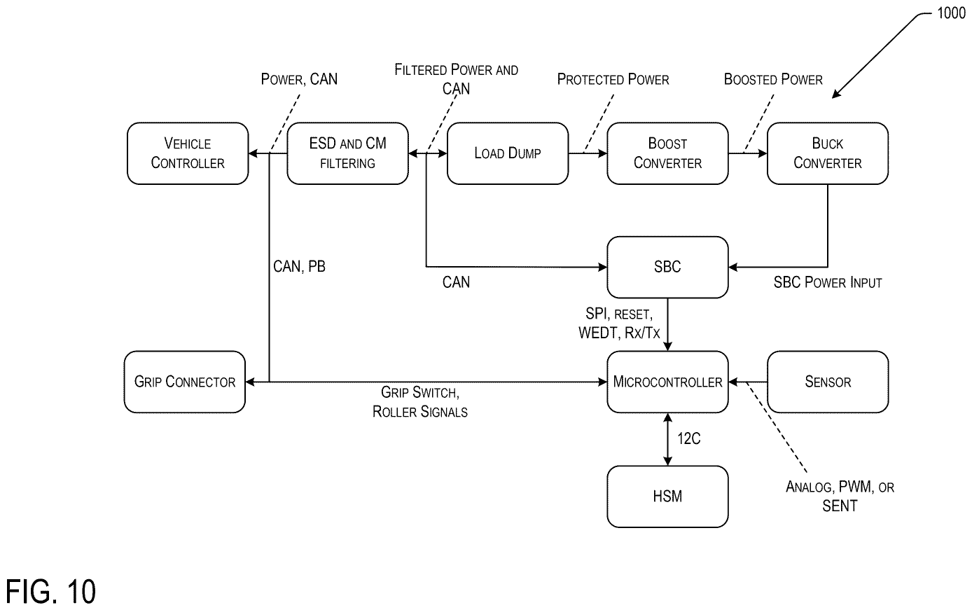

FIG. 10 is a schematic diagram showing a joystick assembly integration architecture that accommodates both low and high grip signal content. More specifically, and as illustrated in FIG. 10, an electronic architecture 1000 provides a joystick base digital communication bus connection to a vehicle digital communication system with capability for low cost and low content grips or low cost, high content grips. In the example, the low content grip signals are sent to the joystick base with discrete digital or analog signals. The joystick base electronics processes and transmits those processed grip content signals onto the vehicle's digital communication system. Also in the electronic architecture 1000, high content grip signals are processed and transmitted from the grip directly onto the vehicle's digital communication system. The joystick base architecture provides the connection for the grip directly to the vehicle's digital communication system.

In conventional joystick applications, two separate joystick base electronic architectures are required. A first conventional architecture connects a high content grip with digital communication bus connection directly to the vehicle's digital communication system. A second conventional architecture passes discrete digital or analog signals from a low content grip directly to the vehicle's ECU. These conventional architectures do not accommodate processing of discrete digital or analog grip signals within the joystick base to be communicated to the vehicle's digital communication system. Requiring multiple architectures often conventionally involves designing and validating multiple different PCBAs with different architectures, which can be expensive and time consuming.

The electronic architecture 1000 is a common joystick base architecture that can accommodate low or high content grips where grip electronic output formats are determined by their lower cost. The arrangement allows for maximum reuse of the initial validation, reducing time to market and cost for specific customer applications.

The electronic architecture 1000 includes a new variant allowing for the base electronics processing of discrete grip signals and transmitting them via a digital communication interface with the machine/vehicle. The architecture 1000 includes both low and high content grip options within one design for the joystick base architecture. Moreover, the architecture 1000 requires no or very small design changes to meet application specific requirements which allows for low time and workload to comply with functional safety requirements. FIG. 10 shows the architecture.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A joystick assembly comprising:
a housing defining a bore;
a cartridge disposed in the bore, the cartridge comprising:
a plunger,
a plunger follower disposed in a volume defined by the plunger, a first end of the plunger follower contacting the plunger,
a spring disposed in the volume and biasing the plunger away from the plunger follower,
a magnet retainer coupled to a second end of the plunger follower,
a first magnet retained in the magnet retainer, and
a second magnet retained in the magnet retainer, the first magnet and the second magnet being retained such that a north pole of the first magnet is adjacent a north pole of the second magnet or such that a south pole of the first magnet is adjacent a south pole of the second magnet;
a sensor disposed to sense a magnetic field associated with the first magnet and the second magnet; and
an interface configured to interact with the plunger such that movement of the interface causes movement of the plunger.

2. The joystick assembly of claim 1, wherein the bore is a first bore, the housing further defining one or more second bores spaced from the first bore, the joystick assembly further comprising:
one or more second cartridges disposed in the one or more second bores, individual of the second cartridges comprising:
a second plunger;
a second plunger follower disposed in a second volume defined by the second plunger, a first end of the second plunger follower contacting the second plunger, and
a second spring disposed in the second volume and biasing the second plunger away from the second plunger follower.

3. The joystick assembly of claim 2, wherein the second plunger is opposite the plunger, relative to an axis of the interface.

4. The joystick assembly of claim 3, wherein the individual of the second cartridges further comprises:
a second magnet retainer coupled to a second end of the second plunger follower;
a third magnet in the second magnet retainer; and
a fourth magnet in the magnet retainer, the joystick assembly further comprising:
a second sensor disposed to sense a magnetic field associated with the third magnet and the fourth magnet.

5. The joystick assembly of claim 1, wherein the interface is configured to pivot relative to the plunger.

6. The joystick assembly of claim 5, further comprising a stop configured to inhibit pivoting of the interface.

7. The joystick assembly of claim 6, wherein the stop comprises a contoured surface configured to be contacted by a portion of the interface to inhibit pivoting of the interface.

8. The joystick assembly of claim 5, wherein the interface comprises an actuating surface extending outwardly from a central shaft, the actuating surface being disposed to selectively contact and actuate the plunger in response to movement of the central shaft.

9. The joystick assembly of claim 1, further comprising a cartridge spring configured to bias the cartridge out of the bore.

10. The joystick assembly of claim 1, further comprising a retention member configured to retain the cartridge in the bore.

11. The joystick assembly of claim 10, wherein the retention member comprises a contoured wire spring extending between first and second ends, the first and second ends being selectively received in apertures formed in the bore.

12. The joystick assembly of claim 11, wherein the retention member further comprises a tab selectively retained in a receptacle associated with the bore.

13. The joystick assembly of claim 1, wherein the cartridge further comprises:
an intermediate body, the intermediate body defining an upper surface that the plunger contacts and through which the plunger follower extends, wherein the spring contacts the upper surface of the intermediate body.

14. The joystick assembly of claim 1, wherein the cartridge further comprises:
an intermediate body, the intermediate body defining an upper surface and an opening through which the plunger follower extends;
a cartridge retainer at least partially disposed in the opening, the plunger being in contact with the cartridge retainer and the spring extending between a surface of the cartridge retainer and the plunger; and
a cartridge retainer spring biasing the cartridge retainer away from the intermediate body.

15. The joystick assembly of claim 14, wherein the cartridge retainer comprises a tab extending from a bottom surface, the tab being configured to cooperate with the opening in the intermediate body to selectively retain the cartridge retainer relative to the intermediate body against a biasing force of the cartridge retainer spring.

16. A cartridge for use in a joystick assembly, the cartridge comprising:
a plunger;
a plunger follower disposed in a volume defined by the plunger, a first end of the plunger follower contacting the plunger;
a spring disposed in the volume and biasing the plunger away from the plunger follower;
a magnet retainer coupled to a second end of the plunger follower;
a first magnet retained in the magnet retainer; and
a second magnet retained in the magnet retainer, the first magnet and the second magnet being retained such that a north pole of the first magnet is adjacent a north pole of the second magnet or such that a south pole of the first magnet is adjacent a south pole of the second magnet.

17. The cartridge of claim 16, further comprising:
an intermediate body, the intermediate body defining an upper surface that the plunger contacts and through which the plunger follower extends, wherein the spring contacts the upper surface of the intermediate body.

18. The cartridge of claim 16, further comprising:
an intermediate body, the intermediate body defining an upper surface and an opening through which the plunger follower extends;
a cartridge retainer at least partially disposed in the opening, the plunger being in contact with the cartridge retainer and the spring extending between a surface of the cartridge retainer and the plunger; and
a cartridge retainer spring biasing the cartridge retainer away from the intermediate body.

19. The cartridge of claim 18, wherein the cartridge retainer comprises a tab extending from a bottom surface, the tab being configured to cooperate with the opening in the intermediate body to selectively retain the cartridge retainer relative to the intermediate body against a biasing force of the cartridge retainer spring.

20. The cartridge of claim 16, wherein the magnet retainer comprises one or more tabs configured to deflect away from a volume defined by the magnet retainer to facilitate overtravel of the plunger follower when inserted into the magnet retainer.
